(19) United States
(12) Patent Application Publication
(10) Pub. No.: US 2016/0072772 A1
(43) Pub. Date: Mar. 10, 2016

(54) Process for Secure Document Exchange

(71) Applicants: Arturo Geigel, Bayamon, PR (US); Gina Colon, Bayamon, PR (US)

(72) Inventors: Arturo Geigel, Bayamon, PR (US); Gina Colon, Bayamon, PR (US)

(21) Appl. No.: 14/848,209

(22) Filed: Sep. 8, 2015

Related U.S. Application Data
(60) Provisional application No. 62/047,435, filed on Sep. 8, 2014.

(51) Int. Cl. H04L 29/06; H04L 9/08; G06F 21/60

(52) U.S. Cl. CPC H04L 63/045; G06F 21/606; H04L 9/0861; H04L 9/0897

(57) ABSTRACT

The present disclosure provides a computer security system with one-to-many relationship between the asymmetric key that encrypts one or more symmetric keys and the method of securing the database that manages said relationship. Further it has a one-to-one relationship between symmetric keys and its associated document and permissions, allows for control of delegation of said documents and permissions as it is transferred along compartments to a second user which is the receiver of the document. In addition has compartments comprising an interface that integrates with a document storage as well as a storage of permissions and key relations in a multi user environment and further provides for the control of the primary compartment in the emission and cancellation of privileges by revoking asymmetric as well as symmetric keys within the document management system.

### STATEMENT REGARDING FEDERALLY SPONSORED RESEARCH AND DEVELOPMENT

N/A

### RELATED APPLICATIONS

N/A

### BACKGROUND OF THE INVENTION

1. Field of the Invention

The present invention relates generally to computer security and more specifically to allow the secure storage and transfer of documents between computers.

2. Discussion of the Background

The prior art in the category of encryption is well established. Within this category is the application of encryption to information stored on a server. U.S. Pat. Nos. 6,449,721; 6,339,825; and 6,289,450 describe the use of a server which associates an encryption/decryption key pair and access policy with the information and its method of retrieval. U.S. Pat. Nos. 6,728,762 and 6,636,889 provide a collaboration space consisting of rooms. U.S. Pat. No. 6,807,633 describes a digital signature system that includes a data receiver for receiving an electronic document over a network; an encryption key database, and a signature processor in communication with the encryption key database and the data receiver. The encryption key database includes encryption key records, each being associated with a subscriber of the database and identifying an encryption key uniquely associated with the subscriber. U.S. Pat. Nos. 6,950,943 and 6,839,843 use a repository or database managed by a third party to store the document without having to trust the administrator of the repository. U.S. Pat. No. 6,978,376 describes a method of controlling the distribution of a segment of encrypted electronic information. U.S. Pat. No. 6,185,681 describes a method of encryption and decryption in which cryptographic methods provide transparent encryption and decryption of documents in an electronic document management system by adding a software module to an electronic document management system.

U.S. Pat. No. 6,598,161 discloses methods, systems and computer program products which encrypt a document by dividing the document into at least a first portion having a first security level and a second portion having a second security level.

U.S. Pat. No. 6,061,448 describes a method and system for secure document delivery over a wide area network, such as the Internet. A sender directs a Delivery Server to retrieve an Intended recipient's public key. The Delivery Server dynamically queries a certificate authority and retrieves the public key.

The public key is transmitted from the Delivery Server to the sender. The sender encrypts the document using a secret key and then encrypts the secret key using the public key. Both document encrypted secret keys are encrypted and uploaded to the Delivery Server, and Transmitted to the Intended recipient. The Intended recipient then uses the private key associated with the public key to decrypt the secret key, and use the secret key to decrypt the document. In an alternative, preferred embodiment of the invention, the sender uses the public key to encrypt the document. In yet another embodiment, the server transmits the document to the Delivery Server for encryption.

The current embodiment differs from the previous art in a novel way by extending the concept of a document management system in a compartmentalized multi-user environment using asymmetric/symmetric one-to-many relationships and associations of permissions of said document management system. All cited prior art lacks an embodiment which manages a multi user environment in an efficient manner making such art cumbersome and difficult to implement. The complexity grows and the prior art becomes less effective when the security architecture is extended to a multi user compartmentalized environment. The prior art also does not consolidate the roles of the user with the inheritance of permissions as it is implemented with public/private key pairs. The prior art does not consolidate an easy to use asymmetric key/permission scheme and relies on having them separately. This is an inconvenience for the user making such process more cumbersome than necessary.

### SUMMARY OF THE INVENTION

The current invention differs from the prior art in that it has a one-to-many relationship between the asymmetric key that encrypts one or more symmetric keys and the method of securing the database that manages this relationship. In addition, it has a one-to-one relationship between symmetric keys and its associated document and permissions. The present invention also allows for control of delegation of said documents and permissions as it is transferred along compartments to a second user which is the receiver of the document. Furthermore, the invention has compartments comprising an interface that integrates with a document storage as well as a storage of permissions and key relations in a multi user environment. The invention also provides for the control of the primary compartment in the emission and cancellation of privileges by revoking asymmetric as well as symmetric keys within the document management system. Finally, the invention allows for the control of cycling asymmetric as well as symmetric keys in case a key is compromised. This re-emission of keys is delegated to other compartments in a transparent way to the users of other compartment.

The prior art, including U.S. applications Nos. 2010/0195824 and 2007/011873, makes no mention of the complexity of solving the issues involved in managing a plurality of documents as they are stored in a medium or exchanged through a communications channel. Similarly, none of the prior art discloses how to correlate multiple messages as they are stored with individual encryption keys assigned per documents. While the inventions described in U.S. Pat. Nos. 6,728,762 and 6,636,889 are designed to store content. They do not address the complexity of managing multiple encryption keys per user and per document as they are stored by different users and transmitted through one or more computers using an encryption system.

### BRIEF DESCRIPTION OF THE INVENTION

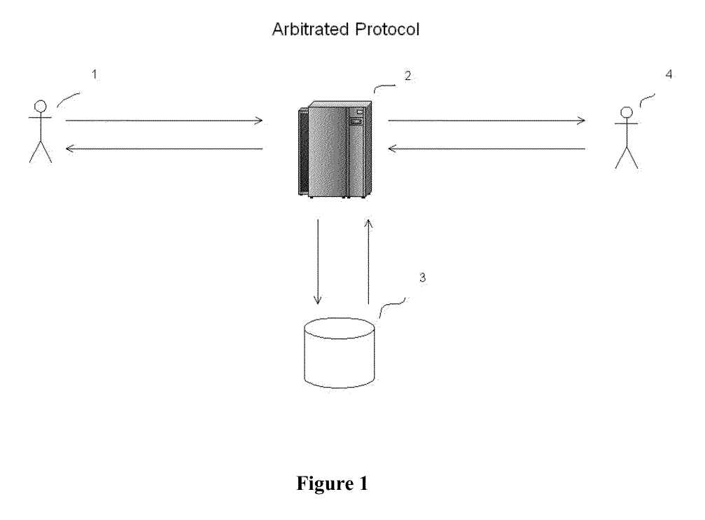

FIG. 1 represents the desired embodiment of the process which is an arbitrated transaction.

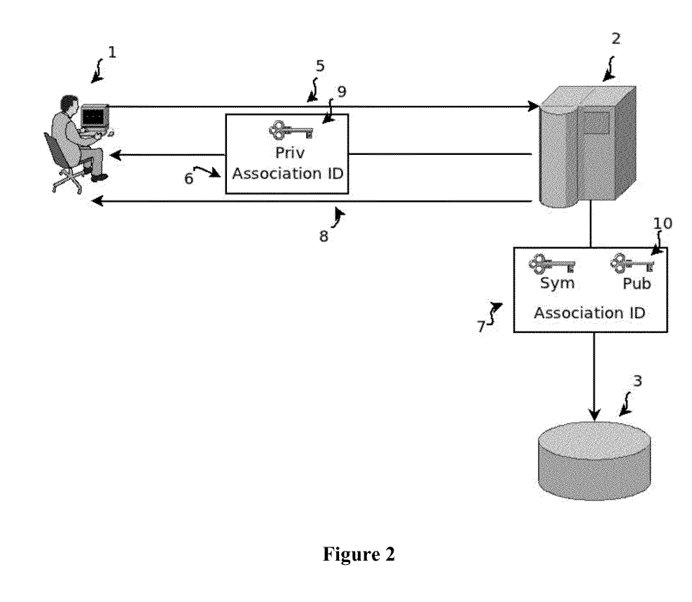

FIG. 2 shows the initial setup of the container.

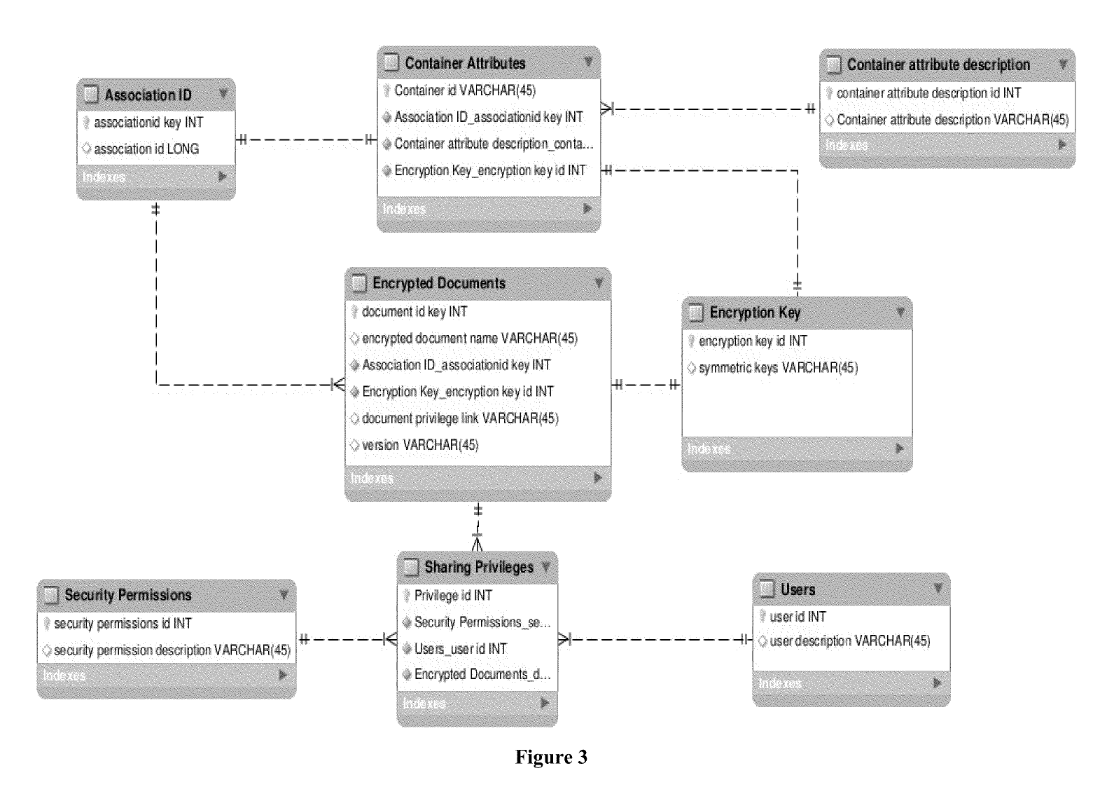

FIG. 3 shows a typical conception of the compartment attributes.

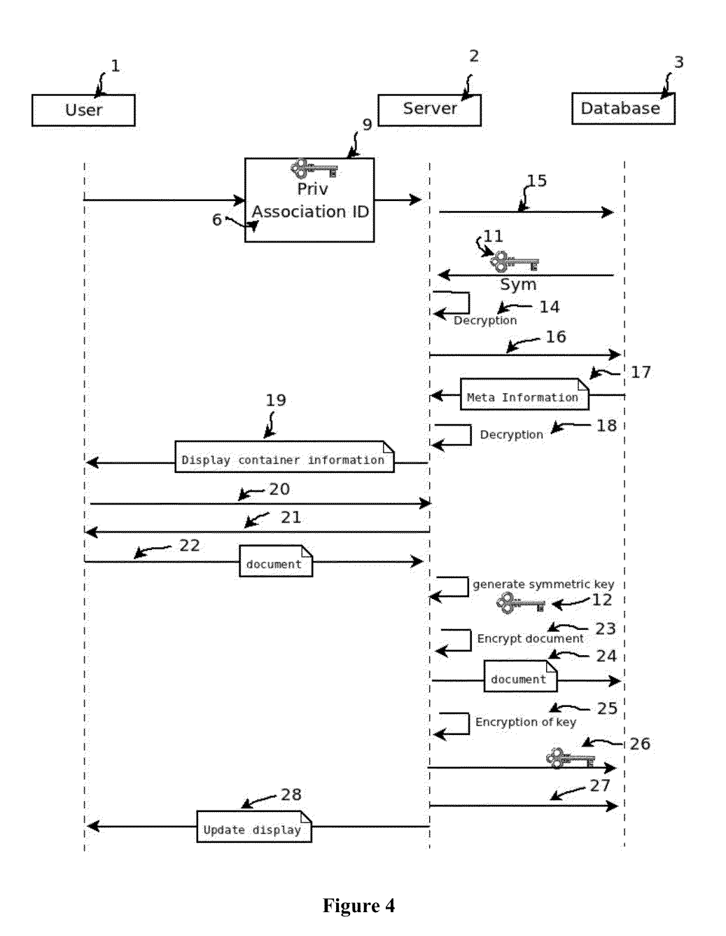

FIG. 4 shows the process of document upload.

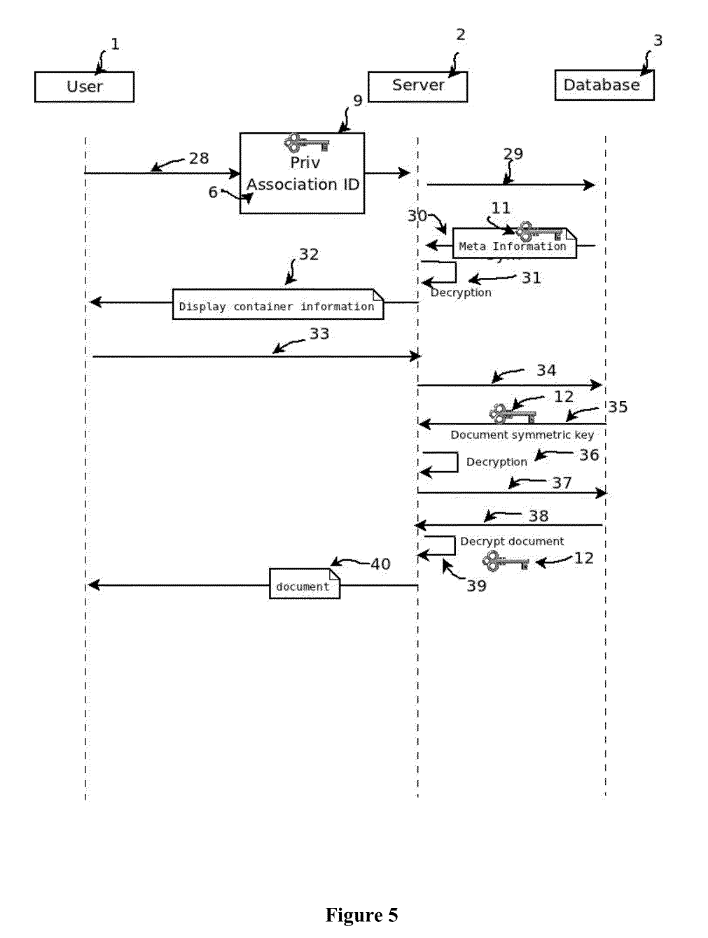

FIG. 5 shows the document download/modification by compartment owner.

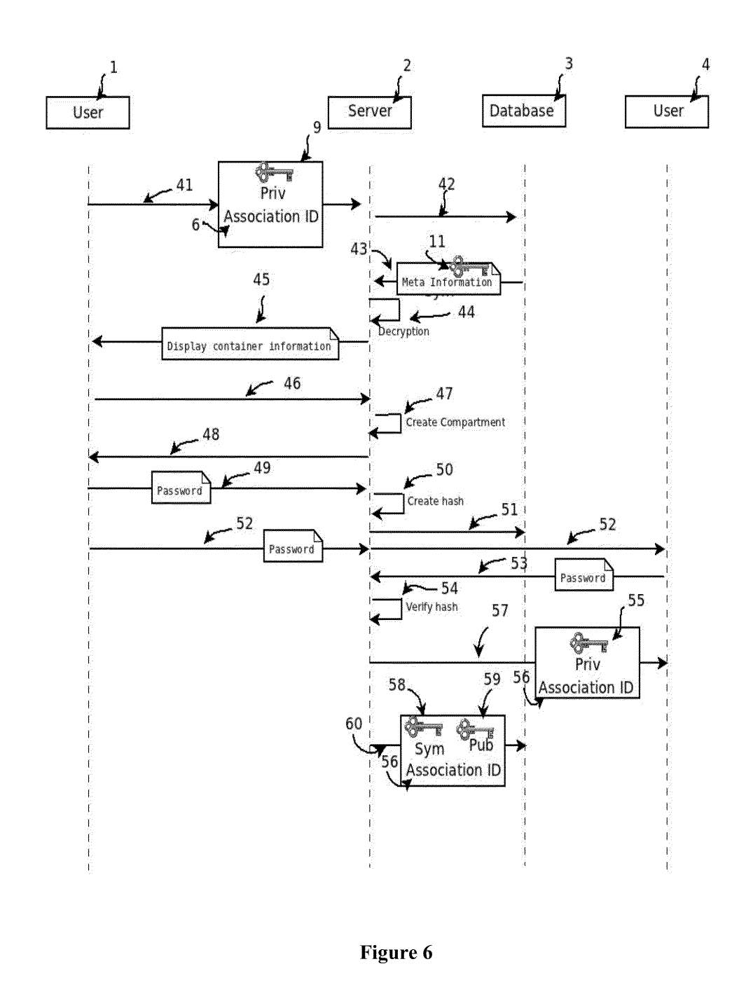

FIG. 6 shows a typical embodiment of the process of creating a new user with its accompanying compartment.

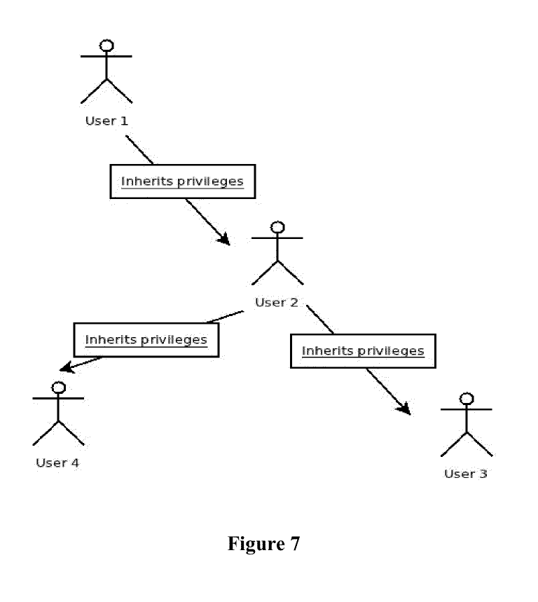

FIG. 7 shows the typical embodiment of a key/document exchange between compartments of different users.

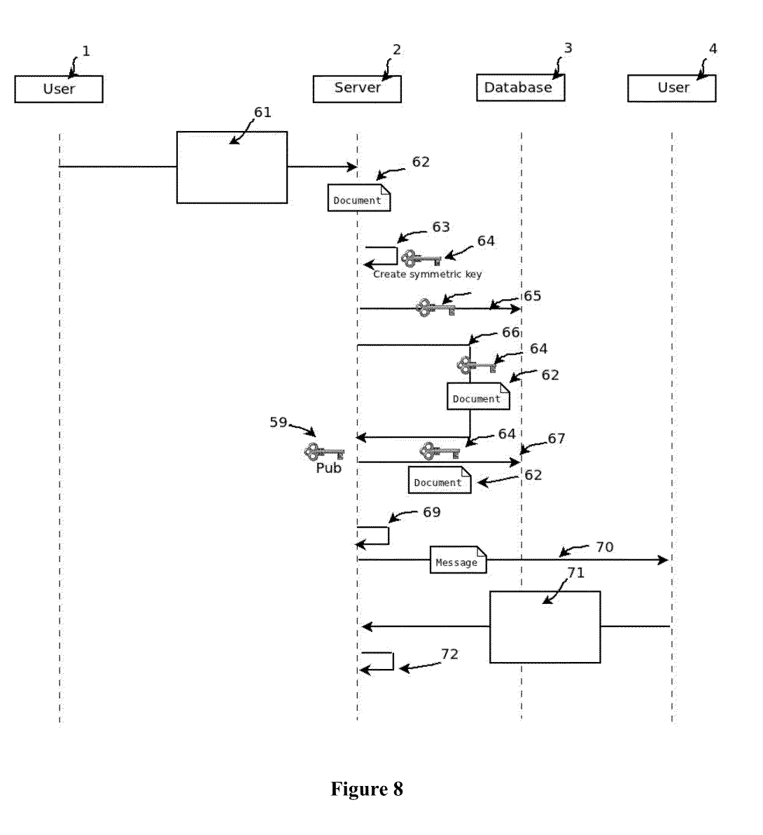

FIG. 8 shows the exemplary embodiment of the document having a newer version being traced via the document privilege link field in the Encrypted document.

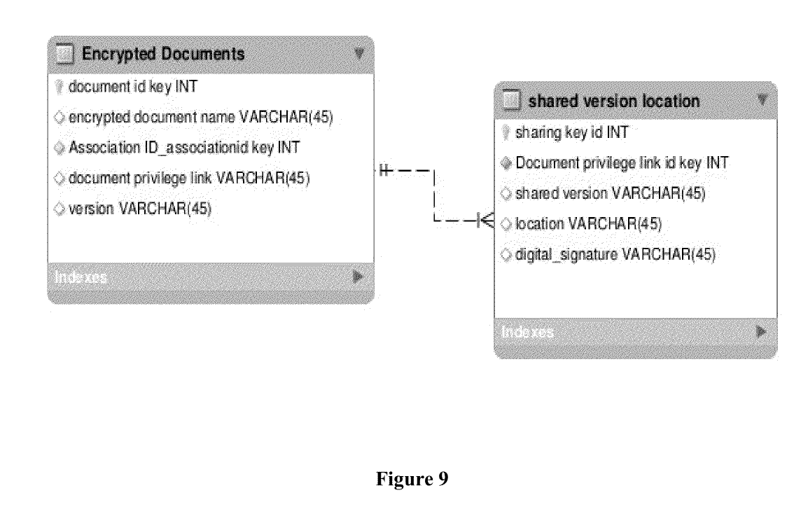

FIG. 9 shows the field points to an unencrypted table.

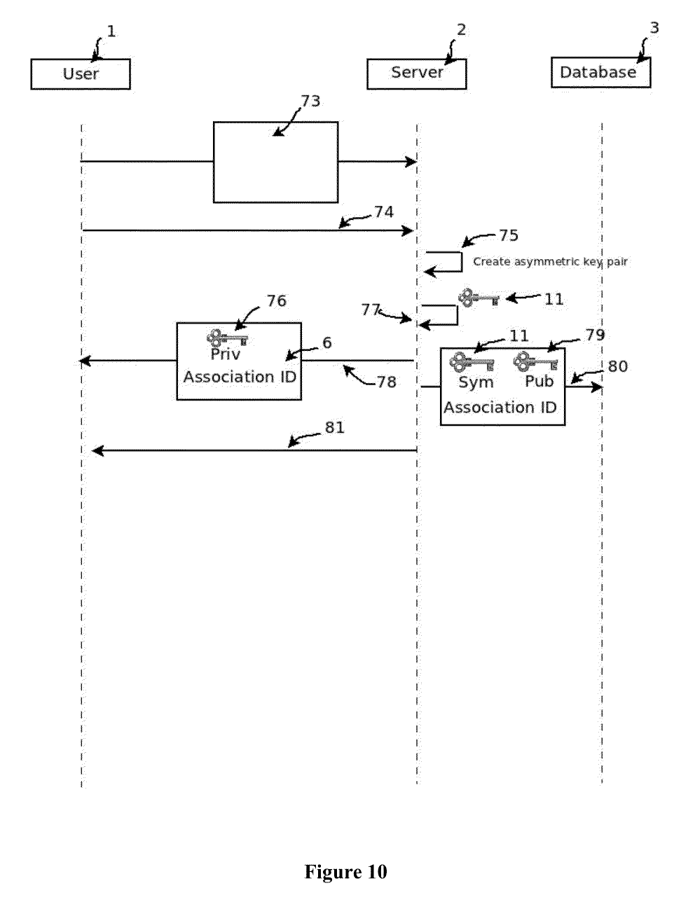

FIG. 10 shows the process of renovating the user's keys in case the user suspects that the asymmetric key pair is compromised or the key lifetime has expired.

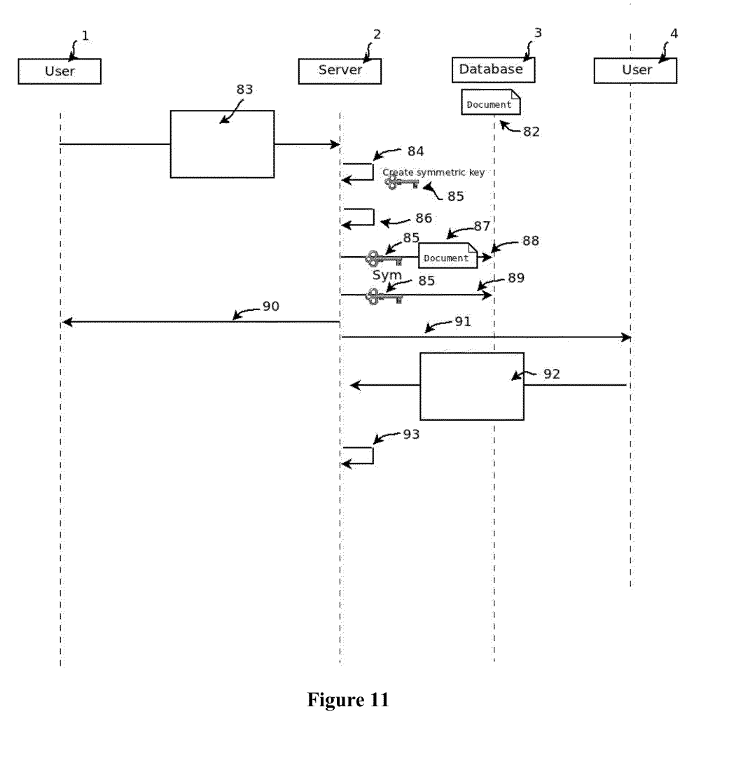

FIG. 11 shows the process of renovating the user's keys in case the user suspects that the symmetric key associated with a document that is shared between users.

### DETAILED DESCRIPTION OF THE INVENTION

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system. The mobile devices and server are directed to computer products comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.). Further a network communication mediums includes, but are not limited to, wired and wireless communications networks, local area networks, wide area networks, intranets, etc.

Although the embodiments disclosed herein may include a particular network configuration, embodiments of the present disclosure may be implemented in a variety of data communication network environments using software, hardware, or a combination of hardware and software to provide the processing functions.

FIG. 1 represents the desired embodiment of the process which is an arbitrated transaction. The user 1 submits information to a server 2 (the arbitrator) in which the main application resides and contacts a database 3. The server or application manages all transactions of the document management system 2 and returns information from the database 3 to the user. If the transaction applies the application contacts a user 4 and passes the information to him. In the preferred embodiment there is no communications between the user 1 and the user 4.

The main concept of the embodiment is the container which is a user repository to store and share encrypted documents through server 2 and store information in database 3. FIG. 2 shows the initial setup of the container. The process is initiated by a person submitting to the application a request that he wants to create a compartment in database 3. The application which can reside on a computer or mobile device of user 1 or in the server 2 (which can be conceived as a typical web application embodiment like JavaScript, CGI or a special client connecting via sockets to remote database) generates the public/private asymmetric encryption key pair and an association key 6. FIG. 2 shows the process where the application resides on the server 2 and the user 1 issues a request 5 to generate the asymmetric key pair and an association key 6. The server 2 creates the association key 6 and asymmetric private key 9 and transmits them to user 1. The user 1 then proceeds to store the asymmetric private key 9 in a secure location. Typically, the user downloads the private key to a USB token or records the key in a CD or other storage media. At the same time, the application creates the compartment where the user's documents are to be stored. The compartment consists of storage space in the server 2 and database entries in the database 3. The compartment will then be associated with the user's asymmetric key pair and an association key 6 which the user 1 holds. The application will also store the asymmetric public key 11 and associates the symmetric public key 11, asymmetric private key 9, and association key 6 with the compartment through the entries in the database 3. The entries in the database are encrypted with the symmetric key, which in turn is encrypted with the user's symmetric public key 11. All the information generated by the database with the exception of the association key 6 are encrypted in this manner. Server 2 then returns a message to the application conveying that the transaction has been completed. This message is sent through a second message stream 7.

A typical conception of the compartment attributes is shown in FIG. 3, where a typical embodiment of the attributes comprises the following:
An association identifier 1 that ties the users private key with the public key and the database fields and storage compartments that can be decrypted with the user's key pair.
Compartment information attribute—compartment information attributes may be information storage location such as a folder or database entry blob, folder hierarchy, etc. Server 2 keeps track of the physical location to the actual compartment location of the document. Thus, the directory structure shown in the web application does not necessarily correlate to the actual directory structure of the server.
Compartment security permissions—permissions control which users have access to the documents and whether the documents are available as read-only or writable.
Documents symmetric keys.
Document versioning—the compartment tracks and provides control over changes to the documents contained therein showing the history for each document including the user who edited the document.
Database of available individuals from who to share information—these are persons that are invited or has invited the owner of the compartment.
   All compartment attributes (with the exception of the association identifier) of that user are encrypted by symmetric keys (There is a one-to-one relationship between attributes and symmetric keys) and these are in turn encrypted by the user's private key.

FIG. 4 shows the process of document upload. The process begins with the user sending his asymmetric private key 9, and association key 6 to the server 2. The server 2 then sends a query 15 to the database 3 to extract the corresponding encrypted symmetric key 11. The symmetric key 11 is decrypted with the user's asymmetric private key 9 using a decryption step 14. The server also requests information via a query 16 the compartment attributes that are necessary for the user's workspace information. The information is sent to the server 2 via a response 17. The symmetric key 9 can then be used to decrypt all the relevant fields of the database pertaining to compartment information attributes such as directory information, security permissions, etc. for the user 1 through encryption process 18. The information is sent to the user in response 19 and then be displayed for the user 1 on the graphical user interface of the computer or mobile device. The user selects the information such as a specific directory where the user wants to store the document and submits it to the server 1 in request 20, the server corroborates the request with the necessary information attributes (permissions, etc.) to guarantee successful upload and respond through response 21. The user then uploads the document 13 and submit it to the server 1 through transmission 22. The server then receives the document and proceed to generate a document symmetric key 12 that will be associated with the document 13. The document 13 is then encrypted with the symmetric key 12 in process 23. The encrypted document 13 is then stored in the database through message 24. The document symmetric key 12 is encrypted with symmetric key 11 in process 25. The encrypted symmetric key is stored in the database 3 in process 26. The corresponding entry to associate the symmetric key 11 with the document symmetric key 12 is also stored in the database 3 in process 27. The graphical user interface is then updated to reflect the changes in the directory structure to include the document in the directory that the user chose for the document through message 28. This last process is key to differentiate the current art with the previous art where managing this process manually with thousands of documents can become prohibitive.

FIG. 5 shows the document download/modification by compartment owner. The document download/modification process starts with the user sending a request 28 to the application to unlock the container. The application uses the association ID 6 to send a request 29 to the database to retrieve the requested container information and the symmetric private key 11. The database responds by retrieving encrypted fields that can be retrieved with the association ID 6 through response 30. The symmetric private key 11 then decrypts the fields of the database in step 31. The server sends the container information to the users display in message 32. The user sends a message 33 to decrypt/download/modify a specific document that resides in his container. The application verifies the authenticity and once the user is identified the application gets the users rights to decrypt the document based on the decrypted information of the container. If the request is valid and it deciphers the information and shows that the user has the rights to download or modify the information, it will request the document symmetric key 12 from the database in step 34. The database responds with message 35 that sends the document symmetric key 12. The document symmetric key 12 is decrypted with the symmetric private key 11 in step 36. At this stage the container is ready to retrieve the document via a request 37 to the database 3 that fetches the document and sends it to server 2 via message 38. The document is then decrypted in step 39 using document symmetric key 12. The application then presents the document to the user for modification or download via message 40. If the user's intention is to download the document, the process ends here. If the user's intention is to modify the document the process continues with the user submitting the information to the application. The application receives the document and then fetches the user's right to modify the document. If the rights of the user show that the user can store the modified data on the server, the application then takes the encryption steps to re-encrypt the document.

FIG. 6 shows a typical embodiment of the process of creating a new user with its accompanying compartment. The document download/modification process starts with the user sending a request 41 to the application to unlock the container. The application uses the association ID 6 to send a request 42 to the database to retrieve the requested container information and the symmetric private key 11. The database responds by retrieving encrypted fields that can be retrieved with the association ID 6 through response 43. The symmetric private key 11 then decrypts the fields of the database in step 44. The server sends the container information to the users display in message 45. The user sends a message 46 to create a user with whom he will share the documents in the container. The application verifies the authenticity and once the user is identified the application gets the users rights to create the user and the permissions that can be granted to that user. For example, the application will not allow the sharing of a document for which the user is not the owner. Once verified that the user can create a compartment, the application proceeds to create a new empty compartment through step 47. In an embodiment, the application then requests that the compartment creator adjudicates a password to the new empty compartment in step 48. The password is sent by the user in step 49, and then hashed and stored in the database 3 with its associated empty compartment in steps 50 and 51, respectively. The user then uses his preferred method of relaying the password to the new user. This step is shown in step 52 as an embodiment in which the user uses the server as relay to send the invite to the user. Another embodiment allows the user to generate the keys and send them to the user. The new user then logs on to the application (or installs the application 2 and database 3 and enters remote database location to access the same through a trust relationship created below between the two application instances), and enters the required password to enter the empty container in step 53.

The application then checks to see if the hash of the password is the same as the stored hash in step 54. If the password is validated then, the application creates a new asymmetric private key 55 and association ID 56 for the user in step 57. The user then downloads and stores the asymmetric private key 55 and association ID 56. After this step the application stores a generated symmetric key 58 and the matching asymmetric public key 59 within the database along with the user's relevant information and privileges inherited from user 1 compartment in step 60. The symmetric key 58 is used to encrypt all of the information from the user 4 container with the exception of the association ID 6 that is used to select the symmetric key 58 which unlocks all the information of the container.

Once the process of setting the container for user 4 is completed then the user 4 can exchange documents with user 1 through the application 3. As part of the process of completion of the container setup the application residing on server 2 relays to the user 1 that the user 4 has setup the compartment and demonstrates the hierarchy of trust of the user in relation to its creator as shown in FIG. 7. This privilege hierarchy relays conceptual information to other users of the system about the level of trust that can be given to the user based on this trust hierarchy.

FIG. 7 shows the typical embodiment of a key/document exchange between compartments of different users. The user requests a document exchange with another user that is already registered in the application. The initial step is to decrypt the document as already established through FIG. 5 and shown as step 61. The resulting decrypted document is shown as document 62. Once the application in server 2 has the decrypted document it generates a symmetric key 64 that will be associated with the shared document 62. This key is stored in the database in step 65. The symmetric key 64 and document 62 are also associated with the user 4 in step 66. This association is completed by using the asymmetric public key 59 from user 4 to encrypt the documents symmetric key and store them with a flag in step 67. The flag serves to raise a notification message in step 69 and relay it to the user in step 70. The user then goes through the process of decrypting his container in step 71 decrypt the key using the asymmetric private key 55 and re-encrypting the key with the symmetric key 58. The symmetric key 58 is then re-encrypted and stored in the container using the asymmetric public key 59 as part of step 72. A final transaction that takes place as part of step 72 is that the entry location is also shared with the user 1 which is the owner of the document.

The process of document removal relays the information of the location in the database of the document that was shared between user 1 and user 4. If user 1 desires to revoke the documents privilege, it uses the information of step 72 to erase the location of the original document. If the user 4 has modified the document and has a newer version it can be traced via the document privilege link field in the Encrypted document table in FIG. 8 which is an encrypted field that is encrypted with a symmetric key stored alongside the documents path and these fields are in turn encrypted with users 1 public key 10. The field points to an unencrypted table, shown in FIG. 9, which contains the latest version information and identity information (such as optional digital certificate signing). This information is used to trace the original shared document's evolution in the system and is shared between user 1 and user 4. The shared fields are also encrypted with a symmetric key and these in turn encrypted with users 1 public key 11.

In an alternate embodiment, the user can also set an expiration date for the document that specifies the life span of the document. After the document expires, it is removed from the system. The user removal consists of a document removal of the owner's document. If the owners document is the original container creator that sent the invitation to the container user, then the container can be removed else it only removes the owner's documents.

FIG. 10 shows the process of renovating the user's keys in case the user suspects that the asymmetric key pair is compromised or the key lifetime has expired. The initial step is to decrypt the document as already established through step 73. The user then sends a request to regenerate the asymmetric key pair in step 74. The application in server 2 creates a new asymmetric key pair in step 75. The user's symmetric key 11 is re-encrypted with the asymmetric private key 76 in step 77. The new asymmetric private key 76 and the association ID 6 is sent to the user in step 78. The symmetric encryption key 11 that has been re-encrypted is sent alongside the asymmetric public key 79 in transmission 80 to the database 3. The user is notified of the changes in transmission message 81.

In an alternate embodiment, when the user suspects the symmetric key 11 has been compromised, the server 3 can regenerate a new symmetric key and re-encrypt all documents on the database that are associated to the symmetric key 11.

FIG. 11 shows the process of renovating the user's keys in case the user suspects that the symmetric key associated with a document that is shared between user 1 and user 4 is compromised. FIG. 11 shows that user 1 is the one initiating the process to change the symmetric key associated to a document 82 via process 83. The process 83 decrypts the containers attributes and checks the required permissions for the documents and the request to regenerate the symmetric key that has been compromised. Process 84 generates the new private key 85 which is used to re encrypt the document in step 86. The document 82 is then presented as the newly encrypted document 87 which is sent with the newly associated private key 85 to database 3 in process 88. The symmetric key 85 is sent with a notification to change the document key to every user that possesses the compromised document 82 and their revised versions in step 89. After step 89 is completed a message to the user 4 is sent in message transmission 91. Once the user 4 notices the message or logs into the system he proceeds to decrypt the container in step 92. The user's trust relationship is checked on the user's 4 trust relationship tree information and if it is trusted, then step 93 of re-encrypting the document with the new private key 85 is automatically executed.

In an alternate embodiment, if the user loses its key, he can then request that a new compartment be created and send a message to other users of the system with whom he has exchanged documents with and if the user accepts the request, then he can re-establish the trust relationship by putting the owner of the files in a lower level of the trust hierarchy as shown in FIG. 7.

In an alternate embodiment, the asymmetric keys can be changed to digital certificates or other equivalent technology. The use of asymmetric keys as typical embodiment do not limit the capabilities of the system in relation to its use of other technologies that satisfy the security constraint demonstrated by the use of asymmetric keys or symmetric keys.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

What is claimed:

1. A secure document exchange system including a non-transitory computer-readable medium comprising:
at least a data base comprising a first compartment;
at least a first computer program medium comprising first computer-executable instructions for requesting said first compartment;
at least a server is connected through a first network communication medium to said first computer program medium, wherein said server comprises at least a second computer program medium including second computer-executable instructions for generating a private asymmetric encryption key, public symmetric encryption key and an association key, wherein said second server is connected through a first network communication medium to said data base;
wherein said server transfers said private asymmetric encryption key and said association key to said computer program medium;
wherein said computer medium stored the private asymmetric encryption key and said association key; and
wherein said server associates said first compartment with public symmetric encryption key, said private asymmetric encryption key, said association key.

2. The secure document exchange system as in claim 1, wherein said compartment comprises compartment attributes;
wherein said compartment attributes comprises association identifier, compartment information attribute, compartment security permissions, documents symetrics keys, document versioning, database of available individuals from who to share information;
wherein said compartment attributes are encrypted by the symmetric keys, wherein the compartment attributes are in a one-to-one relationship with said symmetric keys; and
wherein said symmetric keys are encrypted by the private key.
